(19) United States
(12) Patent Application Publication
(10) Pub. No.: US 2026/0340010 A1
(43) Pub. Date: Oct. 29, 2026

(54) MACHINE LEARNING-BASED DATA INTEGRATION FAILURE DETECTION AND RESOLUTION

(71) Applicant: Dell Products L.P., Round Rock, TX (US)

(72) Inventors: Furkan Mohd Nisar, Ambedkar Nagar (IN); Hemanth Kumar, Kadiri (IN); Ruchi Agarwal, Ghaziabad (IN); Dinesh Koppada, Bengaluru (IN); Vivek Bhargava, Bangalore (IN)

(21) Appl. No.: 19/192,692

(22) Filed: Apr. 29, 2025

(51) Int. Cl. G06F 16/334; G06F 16/25; G06F 40/295

(52) U.S. Cl. CPC G06F 16/3347; G06F 16/254; G06F 40/295

(57) ABSTRACT

Methods, apparatus, and processor-readable storage media for machine learning-based data integration failure detection and resolution are provided herein. An example computer-implemented method includes identifying a data integration process-related issue by processing log data associated with a data integration process using machine learning techniques; identifying content related to mitigating the data integration process-related issue and/or resolving the data integration process-related issue by processing one or more knowledge bases related to data integration processes using natural language processing techniques; generating at least one action plan, based on portions of the identified content, for mitigating the data integration process-related issue and/or resolving the data integration process-related issue; and automatically executing at least part of the at least one action plan across one or more data sources involved in the data integration process.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

In connection with data management, extract, transform, load (ETL) processes are commonly used, e.g., for data warehousing and analytics. However, conventional ETL workflows are frequently disrupted by issues such as connection failures, the presence of bad records and/or other low quality data, file processing anomalies, etc. These disruptions can lead to latencies and/or system downtime, and require error-prone and resource-intensive intervention to resolve.

### SUMMARY

Illustrative embodiments of the disclosure provide techniques for machine learning-based data integration failure detection and resolution.

An example computer-implemented method includes identifying at least one data integration process-related issue by processing log data associated with at least one data integration process using one or more machine learning techniques. The method also includes identifying content related to one or more of mitigating the at least one data integration process-related issue and resolving the at least one data integration process-related issue by processing one or more knowledge bases related to data integration processes using one or more natural language processing techniques. Further, the method additionally includes generating at least one action plan, based at least in part on portions of the identified content, for one or more of mitigating the at least one data integration process-related issue and resolving the at least one data integration process-related issue, and automatically executing at least part of the at least one action plan across one or more data sources involved in the at least one data integration process.

Illustrative embodiments can provide significant advantages relative to conventional ETL workflows. For example, problems associated with latencies and/or system downtime, as well as error-prone and resource-intensive interventions arising from ETL workflow disruptions are overcome in one or more embodiments through automatically detecting data integration process-related issues using machine learning techniques and dynamically executing generated action plans to mitigate and/or resolve the issues.

These and other illustrative embodiments described herein include, without limitation, methods, apparatus, systems, and computer program products comprising processor-readable storage media.

### BRIEF DESCRIPTION OF THE DRAWINGS

FIG. 1 shows an information processing system configured for machine learning-based data integration failure detection and resolution in an illustrative embodiment.

FIG. 2 shows example pseudocode for implementing data collection and labeling techniques in an illustrative embodiment.

FIG. 3 shows example pseudocode for preprocessing input data using a bidirectional encoder representations from transformers (BERT) model in an illustrative embodiment.

FIG. 4 shows example pseudocode for training a BERT model in an illustrative embodiment.

FIG. 5 shows example pseudocode for implementing log classification techniques in an illustrative embodiment.

FIG. 6 shows example pseudocode for implementing a named entity recognition (NER) model in an illustrative embodiment.

FIG. 7 shows example pseudocode for further implementing the NER model in an illustrative embodiment.

FIG. 8 shows example pseudocode for further implementing the NER model in an illustrative embodiment.

FIG. 9 shows example pseudocode for implementing semantic search techniques in an illustrative embodiment.

FIG. 10 shows example pseudocode for parsing a knowledge base article using natural language processing (NLP) techniques in an illustrative embodiment.

FIG. 11 shows example pseudocode for implementing dependency parsing techniques in an illustrative embodiment.

FIG. 12 shows example pseudocode for implementing an example mapping table in an illustrative embodiment.

FIG. 13 shows example pseudocode for implementing keyword matching techniques in an illustrative embodiment.

FIG. 14 shows example pseudocode for processing prior success rates in an illustrative embodiment.

FIG. 15 shows example pseudocode for processing platform and/or environment relevance in an illustrative embodiment.

FIG. 16 shows example pseudocode for assigning weights to analysis criteria in an illustrative embodiment.

FIG. 17 is a flow diagram of a process for machine learning-based data integration failure detection and resolution in an illustrative embodiment.

FIGS. 18 and 19 show examples of processing platforms that may be utilized to implement at least a portion of an information processing system in illustrative embodiments.

### DETAILED DESCRIPTION

Illustrative embodiments will be described herein with reference to example computer networks and associated computers, servers, network devices or other types of processing devices. It is to be appreciated, however, that these and other embodiments are not restricted to use with the particular illustrative network and device configurations shown. Accordingly, the term “computer network” as used herein is intended to be broadly construed, so as to encompass, for example, any system comprising multiple networked processing devices.

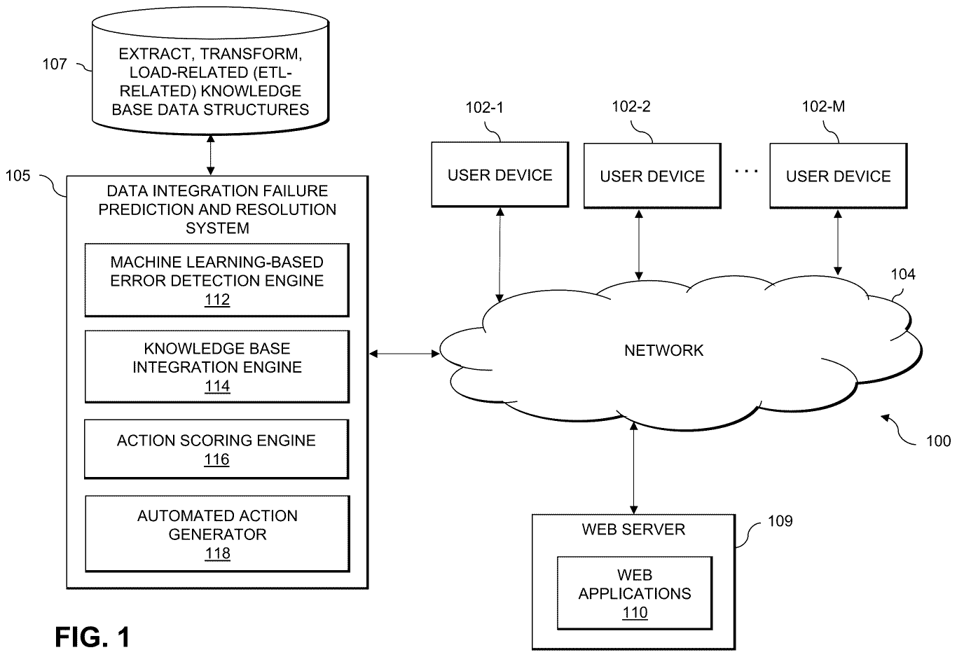

FIG. 1 shows a computer network (also referred to herein as an information processing system) 100 configured in accordance with an illustrative embodiment. The computer network 100 comprises a plurality of user devices 102-1, 102-2, . . . 102-M, collectively referred to herein as user devices 102. The user devices 102 are coupled to a network 104, where the network 104 in this embodiment is assumed to represent a sub-network or other related portion of the larger computer network 100. Accordingly, elements 100 and 104 are both referred to herein as examples of “networks” but the latter is assumed to be a component of the former in the context of the FIG. 1 embodiment. Also coupled to network 104 is data integration failure prediction and resolution system 105 and web server 109, upon which one or more web applications 110 (e.g., various applications involved in data integration actions such as ETL processes) execute.

The user devices 102 may comprise, for example, mobile telephones, laptop computers, tablet computers, desktop computers or other types of computing devices. Such devices are examples of what are more generally referred to herein as “processing devices.” Some of these processing devices are also generally referred to herein as “computers.”

The user devices 102 in some embodiments comprise respective computers associated with a particular company, organization or other enterprise. In addition, at least portions of the computer network 100 may also be referred to herein as collectively comprising an “enterprise network.” Numerous other operating scenarios involving a wide variety of different types and arrangements of processing devices and networks are possible, as will be appreciated by those skilled in the art.

Also, it is to be appreciated that the term “user” in this context and elsewhere herein is intended to be broadly construed so as to encompass, for example, human, hardware, software or firmware entities, as well as various combinations of such entities.

The network 104 is assumed to comprise a portion of a global computer network such as the Internet, although other types of networks can be part of the computer network 100, including a wide area network (WAN), a local area network (LAN), a satellite network, a telephone or cable network, a cellular network, a wireless network such as a Wi-Fi or WiMAX network, or various portions or combinations of these and other types of networks. The computer network 100 in some embodiments therefore comprises combinations of multiple different types of networks, each comprising processing devices configured to communicate using internet protocol (IP) or other related communication protocols.

Additionally, the data integration failure prediction and resolution system 105 can have one or more ETL-related knowledge base data structures 107 configured to store data pertaining to ETL-related issues, keywords related thereto, mitigation and/or resolution actions, action outcomes, etc. The term “data structure,” as used herein, is intended to be broadly construed, so as to encompass, for example, a wide variety of different types of tables, arrays, graphs, trees, linked lists, and additional or alternative data relation mechanisms, as well as portions or combinations thereof. Accordingly, a given data structure can comprise a combination of multiple smaller data structures, possibly of different types, or a portion of a larger data structure. Numerous other arrangements are possible.

The ETL-related knowledge base data structures 107 in the present embodiment are implemented using one or more storage systems associated with the data integration failure prediction and resolution system 105. Such storage systems can comprise any of a variety of different types of storage including network-attached storage (NAS), storage area networks (SANs), direct-attached storage (DAS) and distributed DAS, as well as combinations of these and other storage types, including software-defined storage.

Also associated with the data integration failure prediction and resolution system 105 are one or more input-output devices, which illustratively comprise keyboards, displays or other types of input-output devices in any combination. Such input-output devices can be used, for example, to support one or more user interfaces to the data integration failure prediction and resolution system 105, as well as to support communication between the data integration failure prediction and resolution system 105 and other related systems and devices not explicitly shown.

Additionally, the data integration failure prediction and resolution system 105 in the FIG. 1 embodiment is assumed to be implemented using at least one processing device. Each such processing device generally comprises at least one processor and an associated memory, and implements one or more functional modules for controlling certain features of the data integration failure prediction and resolution system 105.

More particularly, the data integration failure prediction and resolution system 105 in this embodiment can comprise a processor coupled to a memory and a network interface.

The processor may comprise, for example, a microprocessor, an application-specific integrated circuit (ASIC), a system-on-chip (SOC), a field-programmable gate array (FPGA), a central processing unit (CPU), a graphics processing unit (GPU), a neural processing unit (NPU), a data processing unit (DPU), a tensor processing unit (TPU), an arithmetic logic unit (ALU), a digital signal processor (DSP), and/or other similar processing device components, as well as other types and arrangements of processing circuitry, in any combination. At least a portion of the functionality of at least one machine learning system and its associated machine learning algorithms provided by one or more processing devices as disclosed herein can be implemented using such circuitry.

The memory illustratively comprises random access memory (RAM), read-only memory (ROM) or other types of memory, in any combination. The memory and other memories disclosed herein may be viewed as examples of what are more generally referred to as “processor-readable storage media” storing executable computer program code or other types of software programs.

One or more embodiments include articles of manufacture, such as computer-readable storage media. Examples of an article of manufacture include, without limitation, a storage device such as a storage disk, a storage array or an integrated circuit containing memory, as well as a wide variety of other types of computer program products. The term “article of manufacture” as used herein should be understood to exclude transitory, propagating signals. These and other references to “disks” herein are intended to refer generally to storage devices, including solid-state drives (SSDs), and should therefore not be viewed as limited in any way to spinning magnetic media.

The network interface allows the data integration failure prediction and resolution system 105 to communicate over the network 104 with the user devices 102, and illustratively comprises one or more conventional transceivers.

The data integration failure prediction and resolution system 105 further comprises machine learning-based error detection engine 112, knowledge base integration engine 114, action scoring engine 116, and automated action generator 118, the roles and functions of which are further described herein.

It is to be appreciated that this particular arrangement of elements 112, 114, 116 and 118 illustrated in the data integration failure prediction and resolution system 105 of the FIG. 1 embodiment is presented by way of example only, and alternative arrangements can be used in other embodiments. For example, the functionality associated with elements 112, 114, 116 and 118 in other embodiments can be combined into a single module, or separated across a larger number of modules. As another example, multiple distinct processors can be used to implement different ones of elements 112, 114, 116 and 118 or portions thereof.

At least portions of elements 112, 114, 116 and 118 may be implemented at least in part in the form of software that is stored in memory and executed by a processor.

It is to be understood that the particular set of elements shown in FIG. 1 for machine learning-based data integration failure prediction and resolution involving user devices 102 of computer network 100 is presented by way of illustrative example only, and in other embodiments additional or alternative elements may be used. Thus, another embodiment includes additional or alternative systems, devices and other network entities, as well as different arrangements of modules and other components. For example, in at least one embodiment, two or more of data integration failure prediction and resolution system 105, ETL-related knowledge base data structures 107, and web server 109 can be on and/or part of the same processing platform.

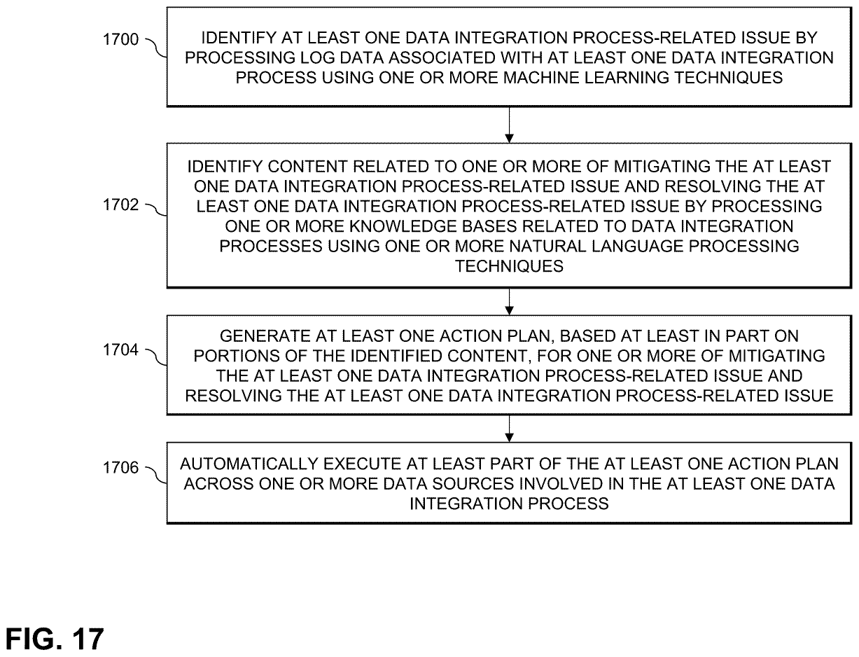

An example process utilizing elements 112, 114, 116 and 118 of an example data integration failure prediction and resolution system 105 in computer network 100 will be described in more detail with reference to the flow diagram of FIG. 17.

Accordingly, at least one embodiment includes machine learning-based data integration failure detection and resolution. Such an embodiment can include performing automated ETL failure prediction, diagnosis and resolution using machine learning-based dynamic adaptation and at least one self-learning centralized knowledge repository and/or data structure for ETL problem solving.

As further detailed herein, one or more embodiments include implementing at least one ETL self-cleansing mechanism designed to work with one or more data integration tools. Such an embodiment includes employing at least one machine learning model that analyzes historical records to identify one or more patterns and/or trends associated with one or more past failures. By understanding such trends, the at least one machine learning model is capable of analyzing and preemptively responding to one or more potential future failures.

Additionally, in such an embodiment, the at least one ETL self-cleansing mechanism automates the processes of error detection and correction, reducing the need for intervention (e.g., manual troubleshooting) and thereby enhancing the efficiency and reliability of ETL workflows by reducing and/or minimizing disruptions and maintaining uninterrupted data flow.

By way of example, one or more embodiments include implementing at least one machine learning model designed to quantify and categorize failure points within one or more ETL processes, enabling the automated generation of corrective code for dynamic (e.g., immediate) self-repair post-failure. Additionally, such a machine learning model is capable of predicting one or more potential failures before ETL execution, thus proactively reducing and/or preventing disruptions in various computing environments (e.g., production environments).

Accordingly, such a self-healing ETL system as detailed herein can automatically resolve one or more ETL workflow-related problems and continue to learn from failures to better predict and handle failures in the future. In at least one embodiment, initial troubleshooting can be guided, for example, by the self-healing ETL system's integration with articles from at least one ETL knowledge base (KB) and/or data structure. The self-healing ETL system can detect a failure and, as part of the process workflow, look up the required KB and/or data structure articles, and automatically apply the corresponding suggested remedy.

Every remedial action can be recorded, including the steps taken and background information related to the corresponding problem. The at least one machine learning model of the self-healing ETL system can be built and/or trained at least in part on such data, which can be stored in an extended knowledge repository and/or data structure. Further, such a machine learning model can learn from failures and corresponding successful remedial actions over time, enabling anticipation of similar failures and/or related problems in the future and automatically applying appropriate remedial actions related thereto. For example, the at least one machine learning model can be trained to record a given ETL process, learn from the process, and refer to at least one relevant knowledge base and/or data structure when model encounters one or more new and/or unknown types of failures.

One or more embodiments can include carrying out the steps as further detailed below. Such a step includes performing error detection, which includes identifying and matching the issue to one or more issues and/or failures associated with data stored in a given KB and/or data structure. In such an embodiment, error detection can include steps of data collection, data preprocessing and labeling carried out, for example, using one or more NLP techniques such as a BERT model, fine-tuning the BERT model, performing log classification and implementing a named entity recognition (NER) model in connection therewith.

Further, in such an embodiment, the steps can also include performing knowledge base integration, which can include carrying out one or more knowledge base lookups (e.g., using keyword matching and/or semantic search), knowledge base parsing, instructions identification, and instruction steps interpretation using one or more mapping tables. The steps can also include scoring (e.g., with respect to KB and/or data structure article weightage), which can include determining and/or identifying scoring criteria (e.g., keyword matching, prior success rate, and/or platform/environment relevance), and assigning weights to each determined criterion.

Additionally, in such an embodiment the steps can include executing at least one automated action in response to the detected error(s) using at least one determined action plan, processing feedback to the at least one automated action (e.g., information pertaining to error details, action(s) taken, and outcome) to at least one centralized knowledge repository and/or data structure with verification and monitoring, and leveraging the at least one centralized knowledge repository and/or data structure for future ETL workflow-related actions.

Accordingly, at least one embodiment includes implementing at least one system which automatically performs ETL error detection, diagnosis and resolution processes using a combination of machine learning techniques, NLP techniques, and automated remedial action generation. For example, such an embodiment can include training and implementing at least one BERT model for contextual understanding of ETL logs (e.g., considering information related to platform, environment, error type, etc.), along with implementing at least one NER model for extracting key information. Such an embodiment can also include factoring in prior success rates of applied remedial actions, enhancing the performance of the models involved.

Further, one or more embodiments include using such models as detailed above to learn and/or understand word associations in ETL-related error logs more efficiently than conventional methods (e.g., keyword-based methods), which can enable more accurate failure classification by using context to distinguish between similar failure descriptions. Also, implementing at least one NER model, as noted above, can provide the ability to extract key components (e.g., database names, IP addresses, error codes, etc.) to render the system and provided solution more versatile. Such extracting can include, for example, extracting structured data from unstructured log messages, and this data can be directly linked to one or more actionable knowledge base and/or data structure articles and/or root cause analysis.

Additionally, as detailed herein, at least one embodiment includes implementing at least one self-learning repository and/or data structure that can continuously improve over time with feedback, becoming smarter and more efficient in addressing ETL failures. Such an embodiment can also include incorporating at least one scoring algorithm that considers multiple aspects such as, e.g., keyword matching, platform and/or environment details, and historical success rates. Also, along with suggesting solutions in the form of automated actions, one or more embodiments include dynamically mapping detected and/or predicted failures or problems to one or more executable scripts, which can then be automatically run according to the corresponding weightage and/or scoring.

Accordingly, through the automation of ETL problem detection, diagnosis and resolution, one or more embodiments can include significantly reducing system downtime as well as the need for error-prone and resource-intensive interventions in response to workflow disruptions. More particularly, and as further detailed herein, such an embodiment can include steps of error detection (e.g., identifying and matching at least one ETL-related issue), knowledge base integration, action scoring, executing a mitigation and/or resolution using an action plan, processing feedback in connection with a related data structure verification and monitoring, and leveraging such a data structure for future ETL-related issue resolution.

In connection with error detection, at least one embodiment includes determining the nature of at least one ETL-related issue by processing log data, error codes and/or system behavior-related data associated with at least one ETL process failure. After classifying the issue according to one or more categories (e.g., connection failure, inconsistent data, conflicting job schedules, etc.), such an embodiment includes searching for and/or identifying one or more relevant articles in the knowledge base data structure. As used herein, an article generally refers to a record and/or documentation pertaining to a solution for one or more past ETL errors, at least one troubleshooting checklist, frequently asked questions (FAQs) describing common data problems, etc. More particularly, one or more embodiments can include using one or more advanced detection algorithms (e.g., one or more BERT models, one or more NER models, one or more anomaly detection models, etc.), as further detailed below, to detect and classify ETL process issues.

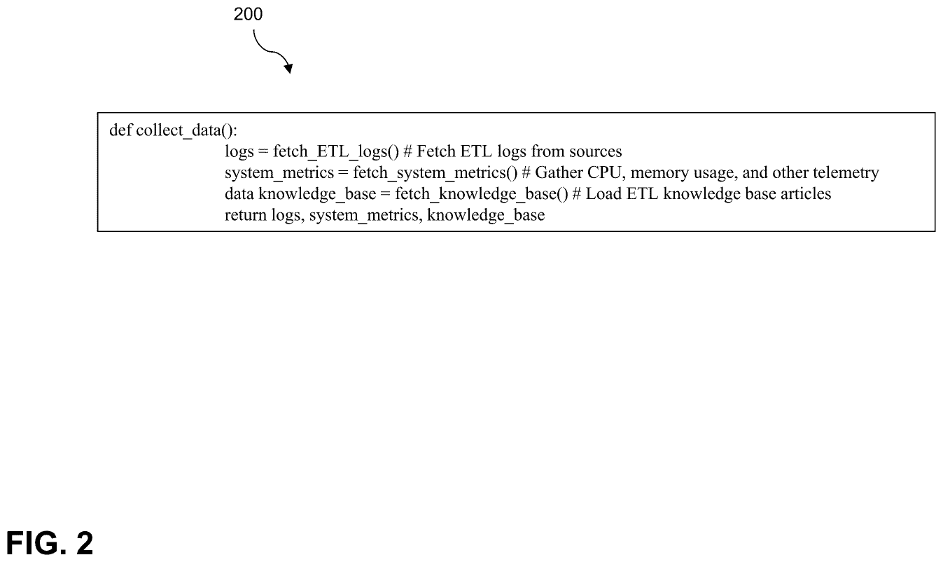

FIG. 2 shows example pseudocode for implementing data collection and labeling techniques in an illustrative embodiment. In this embodiment, example pseudocode 200 is executed by or under the control of at least one processing system and/or device. For example, the example pseudocode 200 may be viewed as comprising a portion of a software implementation of at least part of data integration failure prediction and resolution system 105 of the FIG. 1 embodiment.

The example pseudocode 200 illustrates collecting ETL logs, error codes, system behavior patterns and incident reports from one or more ETL log files and/or related data sources. By way merely of example, collected ETL logs might include the following:

2024-09-30 12:30:45 ERROR: Connection timeout to database XYZ at IP 10.xy.10.1.

2024-09-30 12:31:00 ERROR: Data inconsistency found in table ABC.

2024-09-30 12:32:15 ERROR: Job schedule conflict detected for job ETL_Job_01.

Additionally, collected system metrics might include the following: CPU Usage: 85%; Memory Usage: 75%; Network Latency: 200 milliseconds (ms). Further, based at least in part on the above collected data, one or more embodiments can include labeling the log entries with the appropriate failure types, as follows: Log 1: Connection Failure; Log 2: Data Inconsistency; Log 3: Job Schedule Conflict.

It is to be appreciated that this particular example pseudocode shows just one example implementation of data collection and labeling techniques, and alternative implementations can be used in other embodiments.

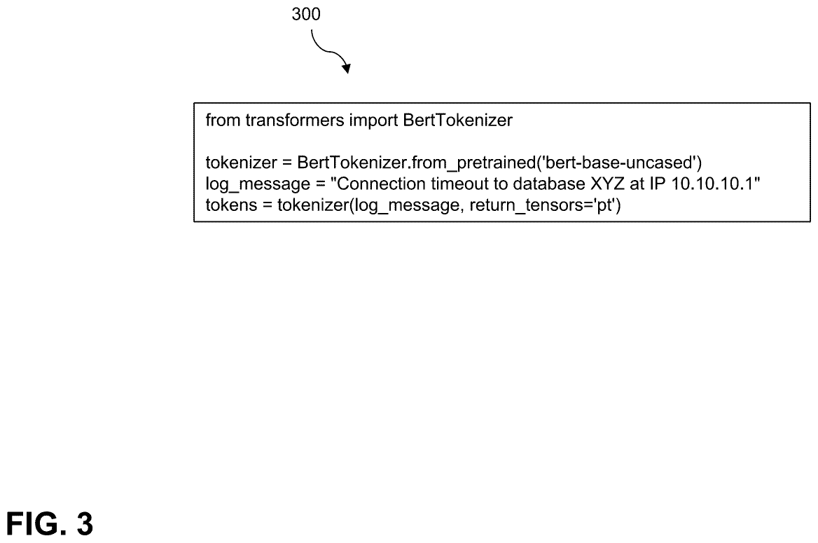

FIG. 3 shows example pseudocode for preprocessing input data using a BERT model in an illustrative embodiment. In this embodiment, example pseudocode 300 is executed by or under the control of at least one processing system and/or device. For example, the example pseudocode 300 may be viewed as comprising a portion of a software implementation of at least part of data integration failure prediction and resolution system 105 of the FIG. 1 embodiment.

The example pseudocode 300 illustrates using a natural language processing (NLP) model such as a BERT model to extract features (such as, for example, error messages, timestamps, error types, etc.) from log data and categorize such features. More particularly, example pseudocode 300 illustrates BERT-based tokenization, which includes breaking down logs into tokens (e.g., error codes, failure types, etc.) for structured analysis. By way of example, using the first ETL log noted above in connection with FIG. 2, corresponding log tokens can be generated as follows: [“2024-09-30,” “ERROR,” “Connection timeout,” “database,” “XYZ,” “IP,” “10.xy.10.1”]

It is to be appreciated that this particular example pseudocode shows just one example implementation of preprocessing input data using a BERT model, and alternative implementations can be used in other embodiments.

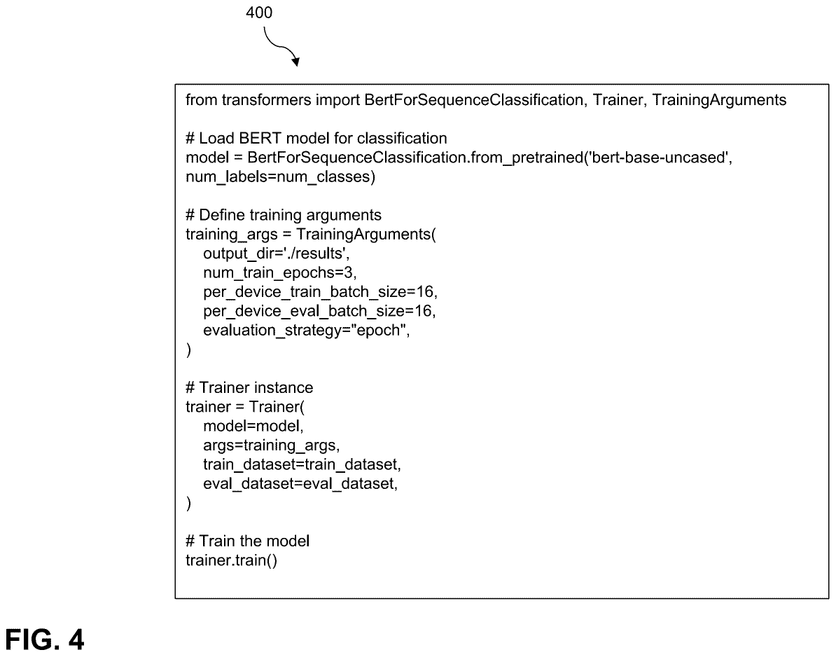

FIG. 4 shows example pseudocode for training a BERT model in an illustrative embodiment. In this embodiment, example pseudocode 400 is executed by or under the control of at least one processing system and/or device. For example, the example pseudocode 400 may be viewed as comprising a portion of a software implementation of at least part of data integration failure prediction and resolution system 105 of the FIG. 1 embodiment.

The example pseudocode 400 illustrates preparing a dataset with tokenized log messages and associated labels, splitting the dataset into sets for validation and training, and using the labeled training dataset to fine-tune the pre-trained BERT model.

It is to be appreciated that this particular example pseudocode shows just one example implementation of training a BERT model, and alternative implementations can be used in other embodiments.

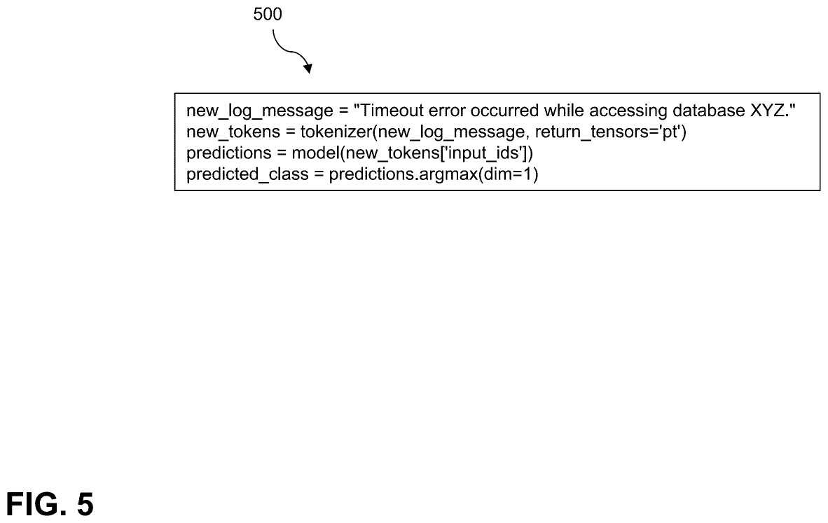

FIG. 5 shows example pseudocode for implementing log classification techniques in an illustrative embodiment. In this embodiment, example pseudocode 500 is executed by or under the control of at least one processing system and/or device. For example, the example pseudocode 500 may be viewed as comprising a portion of a software implementation of at least part of data integration failure prediction and resolution system 105 of the FIG. 1 embodiment.

The example pseudocode 500 illustrates classifying new log entries using the BERT model after it has been trained and/or fine-tuned, such as detailed in connection with FIG. 4.

It is to be appreciated that this particular example pseudocode shows just one example implementation of log classification techniques, and alternative implementations can be used in other embodiments.

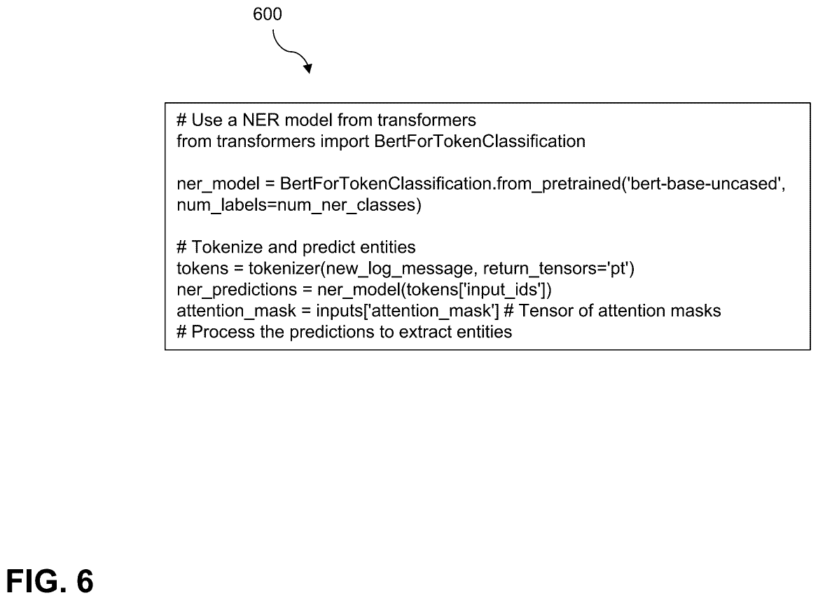

FIG. 6 shows example pseudocode for implementing an NER model in an illustrative embodiment. In this embodiment, example pseudocode 600 is executed by or under the control of at least one processing system and/or device. For example, the example pseudocode 600 may be viewed as comprising a portion of a software implementation of at least part of data integration failure prediction and resolution system 105 of the FIG. 1 embodiment.

The example pseudocode 600 illustrates using an NER model, in conjunction with the BERT model, to extract relevant entities (such as, for example, error types, database names, IP addresses, etc.) from the log entries. Tokenized inputs are formatted for compatibility with the BERT model, and such formatting can include, for example, creating input identifiers (IDs), attention masks, and token type IDs.

It is to be appreciated that this particular example pseudocode shows just one example implementation of an NER model, and alternative implementations can be used in other embodiments.

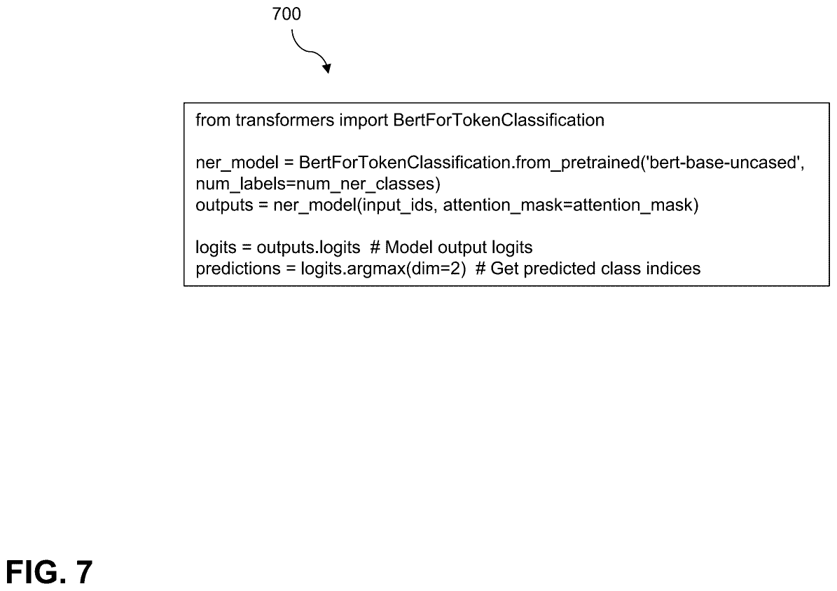

FIG. 7 shows example pseudocode for further implementing the NER model in an illustrative embodiment. In this embodiment, example pseudocode 700 is executed by or under the control of at least one processing system and/or device. For example, the example pseudocode 700 may be viewed as comprising a portion of a software implementation of at least part of data integration failure prediction and resolution system 105 of the FIG. 1 embodiment.

The example pseudocode 700 illustrates feeding the input into a pre-trained NER model for processing. For example, in at least one embodiment, the BERT model can be fine-tuned for one or more NER tasks, allowing the BERT model to predict entity types for each token.

It is to be appreciated that this particular example pseudocode shows just one example implementation of an NER model, and alternative implementations can be used in other embodiments.

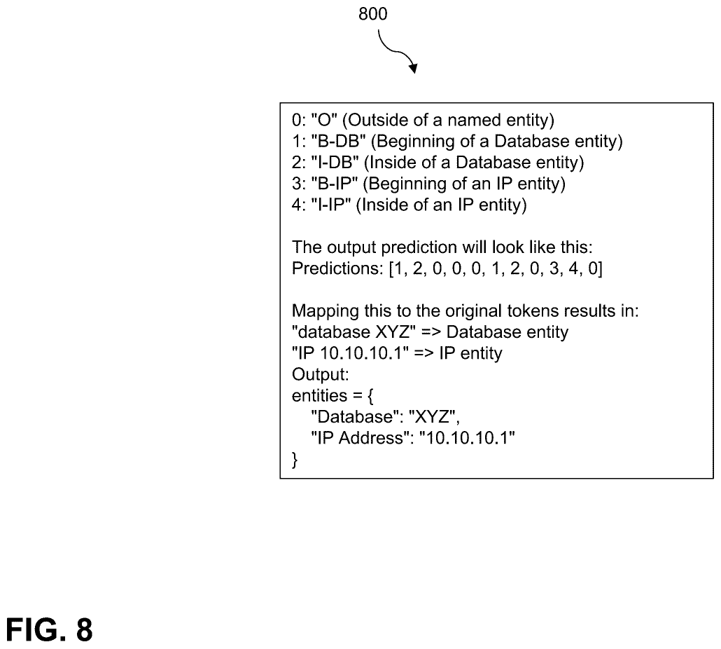

FIG. 8 shows example pseudocode for further implementing the NER model in an illustrative embodiment. In this embodiment, example pseudocode 800 is executed by or under the control of at least one processing system and/or device. For example, the example pseudocode 800 may be viewed as comprising a portion of a software implementation of at least part of data integration failure prediction and resolution system 105 of the FIG. 1 embodiment.

The example pseudocode 800 illustrates finding and/or determining the expected class for each token in the input sequence in the output of the model. Such class indices can then be mapped back to one or more entity labels that can be processed by one or more systems and/or human users.

It is to be appreciated that this particular example pseudocode shows just one example implementation of an NER model, and alternative implementations can be used in other embodiments.

As detailed herein, one or more embodiments also include performing knowledge base integration, which can include integrating model outputs with at least one central ETL knowledge base repository (such as, e.g., ETL-related knowledge base data structures 107 in the example FIG. 1 embodiment), which contains articles on frequently occurring ETL-related issues, how to resolve them, and instructions on troubleshooting procedures. Such a repository can include documentation from multiple sources, including, for example, community-contributed solutions, enterprise support documentation, vendor-provided knowledge bases, etc.

In at least one embodiment, one or more NLP models are configured and/or utilized to parse knowledge base articles. Such parsing can include, for example, reading article text, identifying one or more key instructions therein, and interpreting the steps needed to resolve one or more specific ETL-related issues. By extracting relevant commands, scripts, and/or configurations that can be run directly in the ETL environment, such NLP models decompose the content into manageable steps.

After error detection and classification (e.g., via a BERT model and an NER model), one or more embodiments include searching for and/or looking up relevant knowledge base articles to assist in troubleshooting (e.g., leveraged in connection with keyword matching and semantic search techniques, as detailed further herein). Accordingly, keyword matching can include using extracted entities such as, e.g., error codes, database names, job names, etc., to find one or more articles that mention such items.

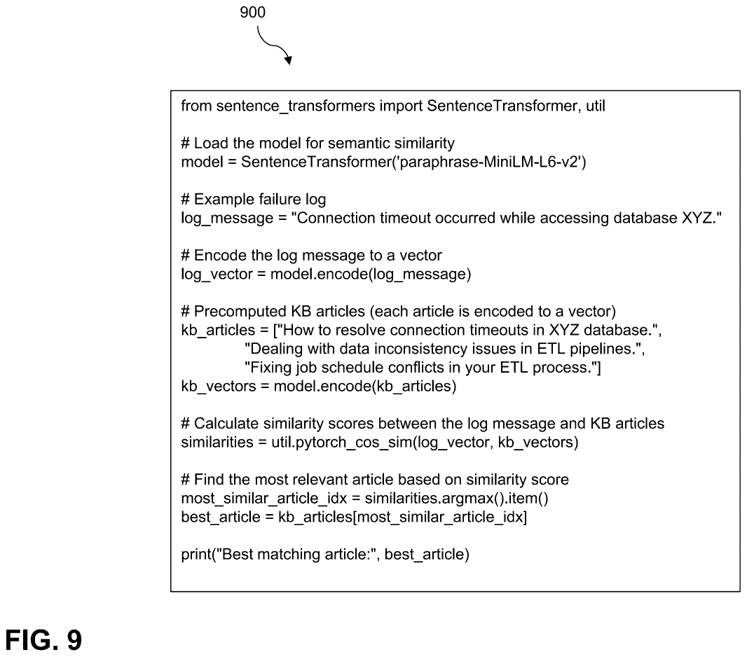

FIG. 9 shows example pseudocode for implementing semantic search techniques in an illustrative embodiment. In this embodiment, example pseudocode 900 is executed by or under the control of at least one processing system and/or device. For example, the example pseudocode 900 may be viewed as comprising a portion of a software implementation of at least part of data integration failure prediction and resolution system 105 of the FIG. 1 embodiment.

The example pseudocode 900 illustrates converting an error and/or failure description to a vector representation, using sentence-BERT techniques (SBERT), in place of an exact keyword match. This representation is then compared to the vector representation of one or more knowledge base articles, and the article with the highest semantic similarity is retrieved.

It is to be appreciated that this particular example pseudocode shows just one example implementation of semantic search techniques, and alternative implementations can be used in other embodiments.

As noted above and further detailed herein, one or more embodiments also include knowledge base parsing, which can include parsing at least one relevant article (selected from a knowledge base) and extracting any applicable instructions and/or procedures related to the detected ETL-related issue. To understand the structure of a knowledge base article, such parsing can be accomplished by dividing the article into multiple sections and looking for one or more patterns within the content.

More particularly, in at least one embodiment, such parsing can include performing text structure analysis, which can include identifying one or more headings, one or more bullet points, and/or numbering within the article content to extract individual instructions. Additionally, such an embodiment includes processing the article to identify one or more regular expression sequences by detecting one or more keywords and/or patterns (such as, for example, “Step 1,” “To resolve this issue,” “Solution,”). Also, such an embodiment can include performing NER and dependency parsing, which involves extracting one or more actionable verbs and/or phrases (e.g., “restart service,” “check the database connection,” etc.) using one or more NLP techniques.

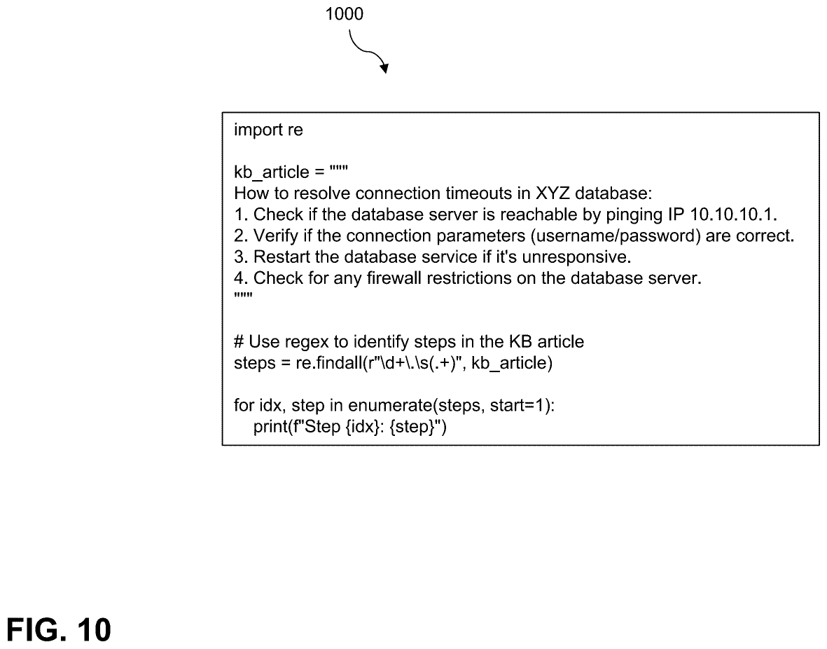

FIG. 10 shows example pseudocode for parsing a knowledge base article using NLP techniques in an illustrative embodiment. In this embodiment, example pseudocode 1000 is executed by or under the control of at least one processing system and/or device. For example, the example pseudocode 1000 may be viewed as comprising a portion of a software implementation of at least part of data integration failure prediction and resolution system 105 of the FIG. 1 embodiment.

The example pseudocode 1000 illustrates parsing a knowledge base article using regular expressions and NLP techniques. By way merely of illustration, an example output of such parsing can include the following:
Step 1: Check if the database server is reachable by pinging IP 10.xy.10.1.
Step 2: Verify if the connection parameters (e.g., username, password, etc.) are correct.
Step 3: Restart the database service if it is unresponsive.
Step 4: Check for any firewall restrictions on the database server.

It is to be appreciated that this particular example pseudocode shows just one example implementation of parsing a knowledge base article using NLP techniques, and alternative implementations can be used in other embodiments.

Further, in one or more embodiments, a subsequent step can include extracting instructions (e.g., important instructions) from the parsed knowledge base article. In an example embodiment, the instructions extracted from the parsed knowledge base article can encompass one or more fundamental procedures and/or actions to be followed in connection with mitigating and/or resolving the detected ETL-related error and/or failure. By way merely of example, extracting instructions can include extracting one or more action verbs, and extracting one or more entities (for example, entities (such as, e.g., database name, IP address, service name, etc.) matched from the log data).

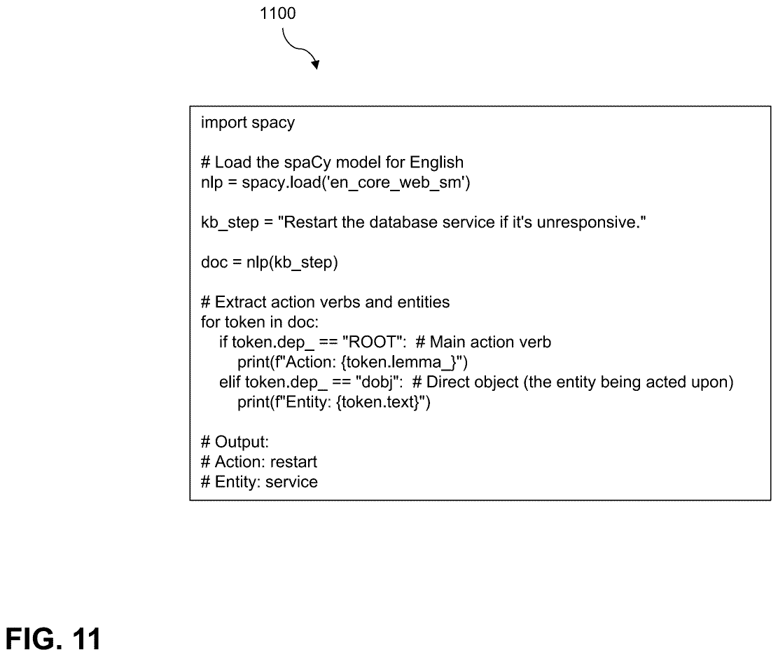

FIG. 11 shows example pseudocode for implementing dependency parsing techniques in an illustrative embodiment. In this embodiment, example pseudocode 1100 is executed by or under the control of at least one processing system and/or device. For example, the example pseudocode 1100 may be viewed as comprising a portion of a software implementation of at least part of data integration failure prediction and resolution system 105 of the FIG. 1 embodiment.

The example pseudocode 1100 illustrates using a SpaCy library in connection with dependency parsing to focus on extracted actions and associated entities. In the example illustrated in example pseudocode 1100, such dependency parsing results in identifying a key instruction to “restart” the “service.”

It is to be appreciated that this particular example pseudocode shows just one example implementation of dependency parsing techniques, and alternative implementations can be used in other embodiments.

Additionally, at least one embodiment includes interpreting such identified steps to automate the mitigation and/or resolution of the detected ETL-related error and/or failure. Such an embodiment can include mapping the noted instructions to one or more particular commands and/or executable scripts (such as, for example, a script to check firewall settings or restart the database service). As part of this mapping, one or more embodiments include defining a table and/or a JavaScript object notation (JSON) dictionary, wherein one or more actions and one or more entities are mapped to appropriate scripts and/or commands. In such an embodiment, an example mapping table can include action verbs (e.g., restart, ping, check, verify, etc.), entities (e.g., database service, server, connection, etc.), and scripts and/or commands, which can include the exact system commands and/or scripts that need to be executed for each action-entity pair.

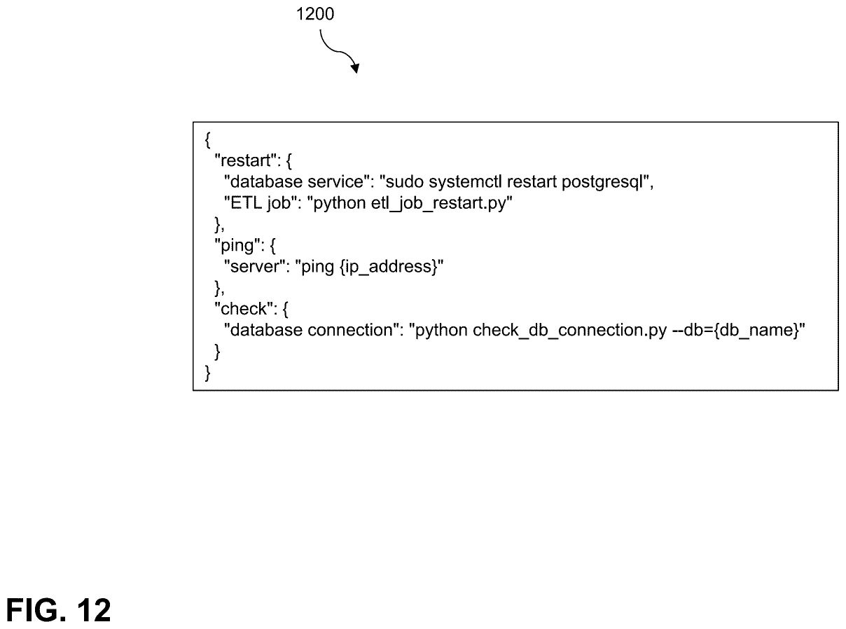

FIG. 12 shows example pseudocode for implementing an example mapping table in an illustrative embodiment. In this embodiment, example pseudocode 1200 is executed by or under the control of at least one processing system and/or device. For example, the example pseudocode 1200 may be viewed as comprising a portion of a software implementation of at least part of data integration failure prediction and resolution system 105 of the FIG. 1 embodiment.

The example pseudocode 1200 illustrates using an action mapping table to find a corresponding command for the identified action and entity. By way of illustration, example pseudocode 1200 involves an instruction to restart the database service if it is unresponsive. Parsing such an instruction can result in the action verb “restart” and the entity “database service.” Using an action mapping table, such a parsed action verb-entity combination can map to a script of “sudo systemctl restart postgresql.”

One or more embodiments can also include implementing one or more parameter substitutions in scripts, wherein, for example, some actions will require one or more additional parameters taken from the log data. For instance, such an embodiment can include dynamically inserting IP addresses, database names, job IDs, etc. into mapped scripts.

It is to be appreciated that this particular example pseudocode shows just one example implementation of an example mapping table, and alternative implementations can be used in other embodiments.

Additionally, as detailed herein, one or more embodiments include implementing an action scoring engine, which can take into account one or more variables such as, e.g., keyword matching, prior success rates of comparable remedies, and the particular platform or environment in which the error and/or failure occurred. In an example embodiment, the article (from the knowledge base) containing the most relevant actions is selected for additional processing. More particularly, in such an embodiment, the scoring system will evaluate each potential solution using criteria including keyword matching (e.g., how closely the knowledge base article matches the keywords extracted from the error logs and issue classification), prior success rate (e.g., historical success rate of the proposed solution for similar issues, based on historical execution data), and platform and/or environment relevance (e.g., compatibility of the solution with the current platform and/or environment, which can increase the likelihood of success).

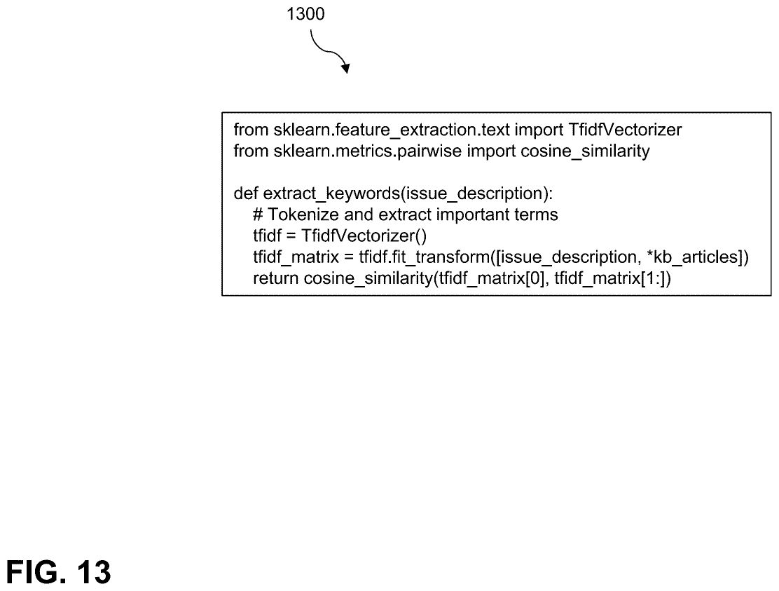

FIG. 13 shows example pseudocode for implementing keyword matching techniques in an illustrative embodiment. In this embodiment, example pseudocode 1300 is executed by or under the control of at least one processing system and/or device. For example, the example pseudocode 1300 may be viewed as comprising a portion of a software implementation of at least part of data integration failure prediction and resolution system 105 of the FIG. 1 embodiment.

The example pseudocode 1300 illustrates using NLP techniques to extract keywords from error logs and issue descriptions. Further, by using cosine similarity, at least one embodiment can include computing the similarity between the issue-related keywords and each knowledge base article.

It is to be appreciated that this particular example pseudocode shows just one example implementation of keyword matching techniques, and alternative implementations can be used in other embodiments.

By way merely of illustration, consider an example use case which involves an issue identified as ETL job failure with an error indicating a connection timeout. Also, the extracted keywords include “connection timeout,” “database,” and “job failure,” and the environment in question is Environment-1. Analysis of the knowledge base identifies three possible solutions:
Solution 1: Article addressing database connection timeout issues in Environment-1.
Solution 2: Article about general connection failures in Environment-2.
Solution 3: Article about connection issues specific to Environment-3.

Accordingly, similarity scores for the possible solutions can be computed as follows:
Solution 1: High keyword overlap for “connection timeout” and “Environment-1;” Similarity score=0.9.
Solution 2: Partial keyword overlap; Similarity score=0.6.
Solution 3: Lower keywords overlap due to Environment-3-specific terms; Similarity score =0.4.

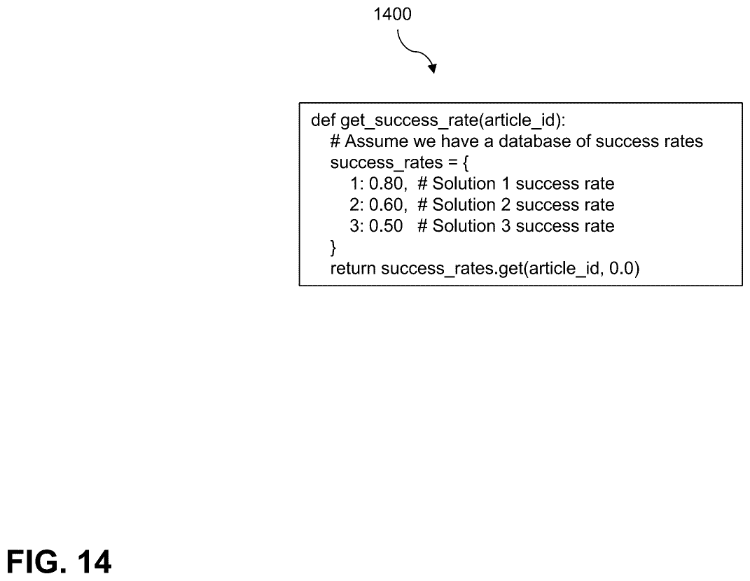

FIG. 14 shows example pseudocode for processing prior success rates in an illustrative embodiment. In this embodiment, example pseudocode 1400 is executed by or under the control of at least one processing system and/or device. For example, the example pseudocode 1400 may be viewed as comprising a portion of a software implementation of at least part of data integration failure prediction and resolution system 105 of the FIG. 1 embodiment.

The example pseudocode 1400 illustrates retrieving (e.g., from ETL-related knowledge base data structures 107) stored success rates of past solutions based at least in part on the content of a selected knowledge base article, and analyzing the historical success rate for each such solution. In example pseudocode 1400, Solution 1 is associated with an 80% success rate based on past data, Solution 2 is associated with a 60% success rate, and Solution 3 is associated with a 50% success rate.

It is to be appreciated that this particular example pseudocode shows just one example implementation of processing prior success rates, and alternative implementations can be used in other embodiments.

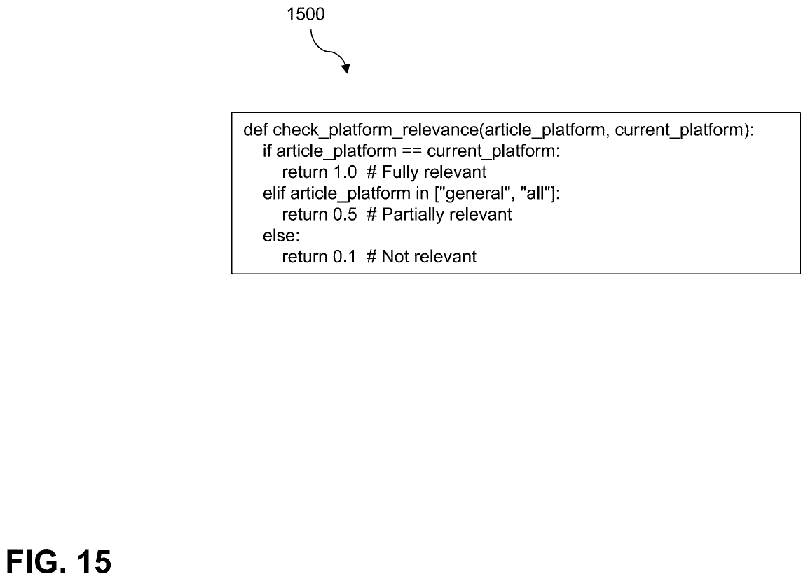

FIG. 15 shows example pseudocode for processing platform and/or environment relevance in an illustrative embodiment. In this embodiment, example pseudocode 1500 is executed by or under the control of at least one processing system and/or device. For example, the example pseudocode 1500 may be viewed as comprising a portion of a software implementation of at least part of data integration failure prediction and resolution system 105 of the FIG. 1 embodiment.

The example pseudocode 1500 illustrates assigning a higher score for articles that are directly applicable and/or relevant to the current platform and/or environment associated with the detected ETL-related error and/or failure.

It is to be appreciated that this particular example pseudocode shows just one example implementation of processing platform and/or environment relevance, and alternative implementations can be used in other embodiments.

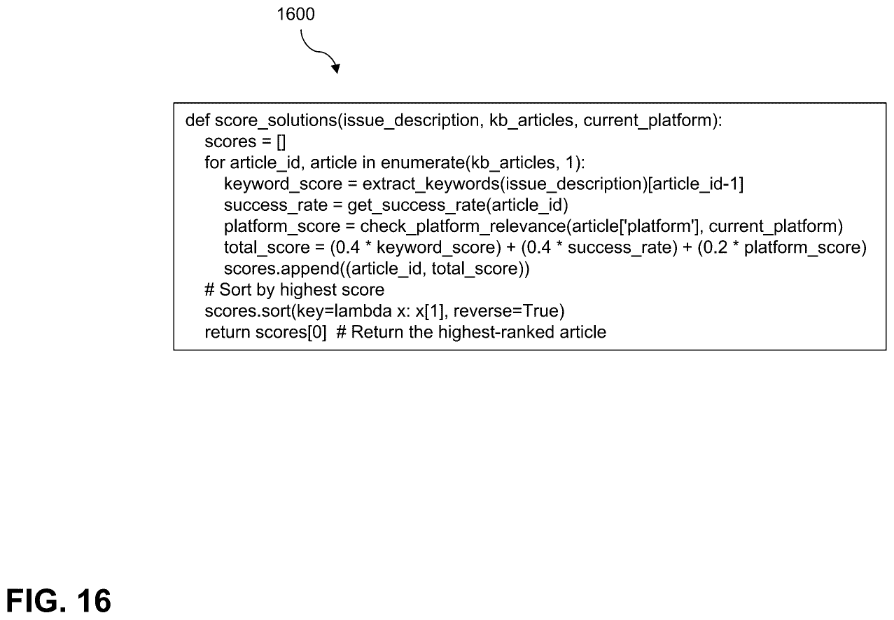

FIG. 16 shows example pseudocode for assigning weights to analysis criteria in an illustrative embodiment. In this embodiment, example pseudocode 1600 is executed by or under the control of at least one processing system and/or device. For example, the example pseudocode 1600 may be viewed as comprising a portion of a software implementation of at least part of data integration failure prediction and resolution system 105 of the FIG. 1 embodiment.

The example pseudocode 1600 illustrates defining a solution score, wherein each of multiple criteria (e.g., keyword matching, prior success rate, platform/environment relevance, etc.) will contribute a certain percentage to the overall score. At least one embodiment includes adjusting the weights assigned to each criterion based at least in part on the importance of each criterion. Further, the overall score for each possible solution can then be calculated combining the individual criterion scores using the assigned weights. In one or more embodiments, the importance of each criterion can be based at least in part on how well the criterion helps solve a given problem. In such an embodiment, this importance can be derived by analyzing and/or processing (e.g., using supervised learning techniques) historical results data, input from one or more experts, etc., and a higher level of importance can result in a higher weight attributed to the criterion.

It is to be appreciated that this particular example pseudocode shows just one example implementation of assigning weights to analysis criteria, and alternative implementations can be used in other embodiments.

One or more embodiments include analyzing the identified solution steps and creating an executable action plan in connection with the corresponding knowledge base article and/or other data from one or more relevant data structures. Such an action plan can describe the scripts and/or instructions that are to be executed by one or more systems and/or one or more software programs to mitigate and/or resolve the issue. For example, the action plan can comprise at least one data structure including executable code segments related to mitigating and/or resolving the issue. Additionally, upon execution of the action plan, one or more of the actions are recorded, illustratively in association with related metadata, to facilitate future issue detection and resolution.

In scenarios wherein a solution includes multiple scripts, at least one embodiment includes calculating a score or weight for each such script, and using such scores or weights to determine the execution order of the scripts. One or more embodiments can also include monitoring the successes and/or failures of each script execution. For example, if a first script successfully resolves the issue, subsequent scripts may not need to be executed. However, if the first script fails, the next script can be automatically executed in priority order.

Further, at least one embodiment includes creating and/or utilizing at least one centralized knowledge repository (e.g., ETL-related knowledge base data structures 107) to record data pertaining to successful fixes. Such an embodiment can further include ensuring that the mitigation and/or resolution process is completed successfully, data integrity is guaranteed, and that no new problems are encountered after the fix. If the problem in question persists after the attempted fix, such an embodiment can include attempting one or more other remedies based at least in part on the knowledge base article scoring. If the fix is successful, such an embodiment includes updating the knowledge base (e.g., ETL-related knowledge base data structures 107) with information pertaining to the issue detected and the remedy applied.

Accordingly, in at least one embodiment, a centralized knowledge repository (e.g., ETL-related knowledge base data structures 107) can hold data pertaining to previous detected ETL-related failures and their associated fixes. More particularly, such data can include information such as failure type (e.g., connection failure, data inconsistency, conflicting schedules, etc.), platform and/or environment, actionable script executed in response to the detected ETL-related failure, result of script execution (e.g., successful, partially successful, or failed), time to resolution (e.g., how long it took to resolve the issue), and success rate (e.g., a percentage indicating how often the script has resolved similar issues in the past). Based at least in part on such periodic and/or continuous updating of the centralized knowledge repository, one or more embodiments include leverage such a centralized knowledge repository in connection with mitigating and/or resolving future ETL-related issues.

FIG. 17 is a flow diagram of a process for machine learning-based data integration failure prediction and resolution in an illustrative embodiment. It is to be understood that this particular process is only an example, and additional or alternative processes can be carried out in other embodiments.

In this embodiment, the process includes steps 1700 through 1706. These steps are assumed to be performed by the data integration failure prediction and resolution system 105 utilizing elements 112, 114, 116 and 118.

Step 1700 includes identifying at least one data integration process-related issue by processing log data associated with at least one data integration process using one or more machine learning techniques. In at least one embodiment, identifying at least one data integration process-related issue includes extracting one or more features from the log data using at least one BERT model. In such an embodiment, extracting one or more features from the log data can include extracting one or more entities from the log data using at least one NER model in conjunction with the at least one BERT model. Additionally or alternatively, identifying at least one data integration process-related issue can include processing log data associated with one or more ETL processes. Further, in at least one embodiment, identifying at least one data integration process-related issue includes classifying the at least one data integration process-related issue according to one or more issue causation-related categories.

Step 1702 includes identifying content related to one or more of mitigating the at least one data integration process-related issue and resolving the at least one data integration process-related issue by processing one or more knowledge bases related to data integration processes using one or more natural language processing techniques. In one or more embodiments, identifying content includes using, in conjunction with a description of the at least one data integration process-related issue, at least one of one or more keyword matching techniques and one or more semantic search techniques. In such an embodiment, using one or more semantic search techniques can include converting at least a portion of the description of the at least one data integration process-related issue to at least one vector representation, and comparing the at least one vector representation to one or more vector representations within the one or more knowledge bases.

Step 1704 includes generating at least one action plan, based at least in part on portions of the identified content, for one or more of mitigating the at least one data integration process-related issue and resolving the at least one data integration process-related issue. In at least one embodiment, generating at least one action plan includes mapping the portions of the identified content to one or more executable scripts of action commands. In such an embodiment, generating at least one action plan can include implementing one or more parameter values from the log data into at least a portion of the one or more executable scripts of action commands.

Additionally or alternatively, generating at least one action plan can include identifying multiple action plans related to one or more of mitigating the at least one data integration process-related issue and resolving the at least one data integration process-related issue, scoring each of the multiple action plans based at least in part on at least one feature weighting operation, and selecting the at least one action plan from the multiple action plans based at least in part on the scoring of each of the multiple action plans. In such an embodiment, the at least one feature weighting operation can include assigning weights to features comprising two or more of level of keyword matching, prior success rate of one or more comparable actions, and at least one of a platform and an environment associated with occurrence of the at least one data integration process-related issue.

Step 1706 includes automatically executing at least part of the at least one action plan across one or more data sources involved in the at least one data integration process. Further, in one or more embodiments, the techniques depicted in FIG. 17 can also include training at least a portion of the one or more machine learning techniques using feedback related to automatically executing the at least part of the at least one action plan.

Accordingly, the particular processing operations and other functionality described in conjunction with the flow diagram of FIG. 17 are presented by way of illustrative example only, and should not be construed as limiting the scope of the disclosure in any way. For example, the ordering of the process steps may be varied in other embodiments, or certain steps may be performed concurrently with one another rather than serially.

The above-described illustrative embodiments provide significant advantages relative to conventional approaches. For example, some embodiments are configured to automatically detect data integration process-related issues using machine learning techniques and dynamically execute generated action plans to mitigate and/or resolve the issues. These and other embodiments can effectively overcome problems associated with latencies and/or system downtime, as well as error-prone and resource-intensive interventions arising from ETL workflow disruptions.

It is to be appreciated that the particular advantages described above and elsewhere herein are associated with particular illustrative embodiments and need not be present in other embodiments. Also, the particular types of information processing system features and functionality as illustrated in the drawings and described above are examples only, and numerous other arrangements may be used in other embodiments.

As mentioned previously, at least portions of the information processing system 100 can be implemented using one or more processing platforms. A given processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform used to implement at least a portion of an information processing system comprises cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components, or portions thereof, are illustratively implemented for use by tenants of such a multi-tenant environment.

As mentioned previously, cloud infrastructure as disclosed herein can include cloud-based systems. Virtual machines provided in such systems can be used to implement at least portions of a computer system in illustrative embodiments.

In some embodiments, the cloud infrastructure additionally or alternatively comprises a plurality of containers implemented using container host devices. For example, as detailed herein, a given container of cloud infrastructure illustratively comprises a Docker container or other type of Linux Container (LXC). The containers are run on virtual machines in a multi-tenant environment, although other arrangements are possible. The containers are utilized to implement a variety of different types of functionality within the system 100. For example, containers can be used to implement respective processing devices providing compute and/or storage services of a cloud-based system. Again, containers may be used in combination with other virtualization infrastructure such as virtual machines implemented using a hypervisor.

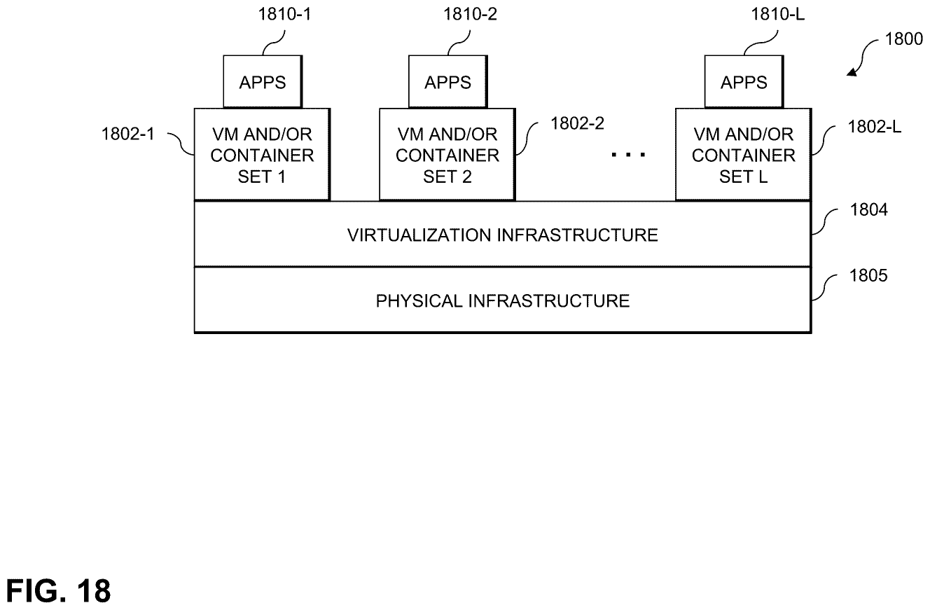

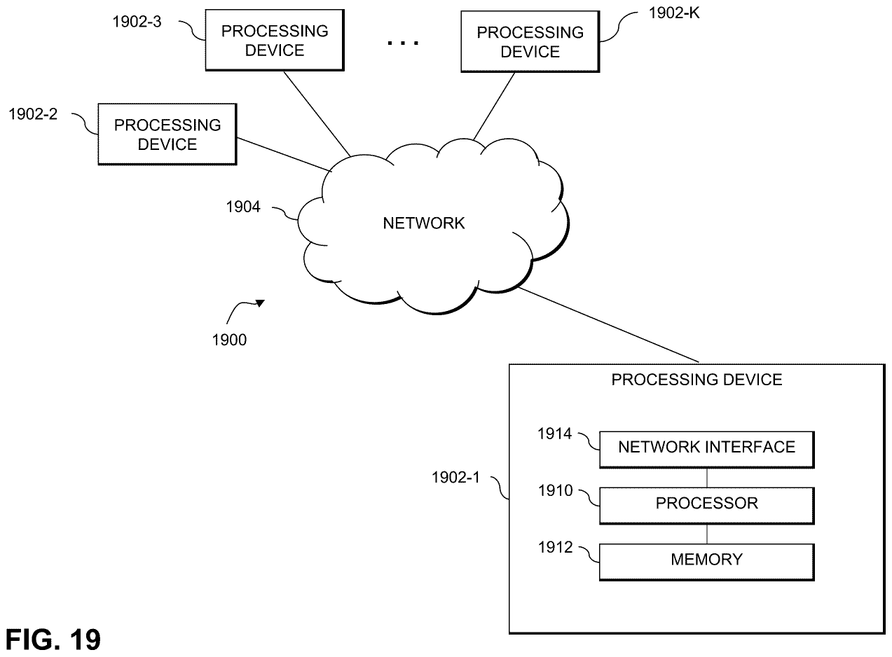

Illustrative embodiments of processing platforms will now be described in greater detail with reference to FIGS. 18 and 19. Although described in the context of system 100, these platforms may also be used to implement at least portions of other information processing systems in other embodiments.

FIG. 18 shows an example processing platform comprising cloud infrastructure 1800. The cloud infrastructure 1800 comprises a combination of physical and virtual processing resources that are utilized to implement at least a portion of the information processing system 100. The cloud infrastructure 1800 comprises multiple virtual machines (VMs) and/or container sets 1802-1, 1802-2, . . . 1802-L implemented using virtualization infrastructure 1804. The virtualization infrastructure 1804 runs on physical infrastructure 1805, and illustratively comprises one or more hypervisors and/or operating system level virtualization infrastructure. The operating system level virtualization infrastructure illustratively comprises kernel control groups of a Linux operating system or other type of operating system.

The cloud infrastructure 1800 further comprises sets of applications 1810-1, 1810-2, . . . 1810-L running on respective ones of the VMs/container sets 1802-1, 1802-2, . . . 1802-L under the control of the virtualization infrastructure 1804. The VMs/container sets 1802 comprise respective VMs, respective sets of one or more containers, or respective sets of one or more containers running in VMs. In some implementations of the FIG. 18 embodiment, the VMs/container sets 1802 comprise respective VMs implemented using virtualization infrastructure 1804 that comprises at least one hypervisor.

A hypervisor platform may be used to implement a hypervisor within the virtualization infrastructure 1804, wherein the hypervisor platform has an associated virtual infrastructure management system. The underlying physical machines comprise one or more information processing platforms that include one or more storage systems.

In other implementations of the FIG. 18 embodiment, the VMs/container sets 1802 comprise respective containers implemented using virtualization infrastructure 1804 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element is viewed as an example of what is more generally referred to herein as a “processing device.” The cloud infrastructure 1800 shown in FIG. 18 may represent at least a portion of one processing platform. Another example of such a processing platform is processing platform 1900 shown in FIG. 19.

The processing platform 1900 in this embodiment comprises a portion of system 100 and includes a plurality of processing devices, denoted 1902-1, 1902-2, 1902-3, . . . 1902-K, which communicate with one another over a network 1904.

The network 1904 comprises any type of network, including by way of example a global computer network such as the Internet, a WAN, a LAN, a satellite network, a telephone or cable network, a cellular network, a wireless network such as a Wi-Fi or WiMAX network, or various portions or combinations of these and other types of networks.

The processing device 1902-1 in the processing platform 1900 comprises a processor 1910 coupled to a memory 1912.

The processor 1910 comprises a microprocessor, an ASIC, an SOC, an FPGA, a CPU, a GPU, an NPU, a DPU, a TPU, an ALU, a DSP, and/or other similar processing device components, as well as other types and arrangements of processing circuitry, in any combination. At least a portion of the functionality of at least one machine learning system and its associated machine learning algorithms provided by one or more processing devices as disclosed herein can be implemented using such circuitry.

The memory 1912 comprises RAM, ROM or other types of memory, in any combination. The memory 1912 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture comprises, for example, a storage array, a storage disk or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 1902-1 is network interface circuitry 1914, which is used to interface the processing device with the network 1904 and other system components, and may comprise conventional transceivers.

The other processing devices 1902 of the processing platform 1900 are assumed to be configured in a manner similar to that shown for processing device 1902-1 in the figure.

Again, the particular processing platform 1900 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage products or devices, or other components are possible in the information processing system 100. Such components can communicate with other elements of the information processing system 100 over any type of network or other communication media.

For example, particular types of storage products that can be used in implementing a given storage system of an information processing system in an illustrative embodiment include all-flash and hybrid flash storage arrays, scale-out all-flash storage arrays, scale-out NAS clusters, or other types of storage arrays. Combinations of multiple ones of these and other storage products can also be used in implementing a given storage system in an illustrative embodiment.

It should again be emphasized that the above-described embodiments are presented for purposes of illustration only. Many variations and other alternative embodiments may be used. Also, the particular configurations of system and device elements and associated processing operations illustratively shown in the drawings can be varied in other embodiments. Thus, for example, the particular types of processing devices, modules, systems and resources deployed in a given embodiment and their respective configurations may be varied. Moreover, the various assumptions made above in the course of describing the illustrative embodiments should also be viewed as examples rather than as requirements or limitations of the disclosure. Numerous other alternative embodiments within the scope of the appended claims will be readily apparent to those skilled in the art.

1. A computer-implemented method comprising:
identifying, in a transformer-based model of a processor-based machine learning system. at least one data integration process-related issue by extracting one or more features from log data associated with at least one data integration process, the processor-based machine learning system further comprising a natural language processing model, wherein the transformer-based model and the natural language processing model are interconnected in a processing pipeline of the processor-based machine learning system;
identifying, in the natural language processing model, content related to one or more of mitigating the at least one data integration process-related issue and resolving the at least one data integration process-related issue by processing one or more knowledge bases related to data integration processes in connection with at least a portion of the one or more extracted features;
generating at least one action plan, based at least in part on portions of the identified content, for one or more of mitigating the at least one data integration process-related issue and resolving the at least one data integration process-related issue; and
automatically executing at least part of the at least one action plan across one or more data sources involved in the at least one data integration process;
wherein the method is performed by at least one processing device comprising a processor coupled to a memory.

2. The computer-implemented method of claim 1, wherein extracting one or more features from the log data associated with at least one data integration process comprises using a bidirectional encoder representations from transformers (BERT) model.

3. The computer-implemented method of claim 2, wherein extracting one or more features from the log data comprises extracting one or more entities from the log data using at least one named entity recognition (NER) model in conjunction with the BERT model.

4. The computer-implemented method of claim 1, wherein identifying content comprises using, in conjunction with a description of the at least one data integration process-related issue, at least one of one or more keyword matching techniques and one or more semantic search techniques.

5. The computer-implemented method of claim 4, wherein using one or more semantic search techniques comprises converting at least a portion of the description of the at least one data integration process-related issue to at least one vector representation, and comparing the at least one vector representation to one or more vector representations within the one or more knowledge bases.

6. The computer-implemented method of claim 1, wherein generating at least one action plan comprises mapping the portions of the identified content to one or more executable scripts of action commands.

7. The computer-implemented method of claim 6, wherein generating at least one action plan comprises implementing one or more parameter values from the log data into at least a portion of the one or more executable scripts of action commands.

8. The computer-implemented method of claim 1, wherein generating at least one action plan comprises identifying multiple action plans related to one or more of mitigating the at least one data integration process-related issue and resolving the at least one data integration process-related issue, scoring each of the multiple action plans based at least in part on at least one feature weighting operation, and selecting the at least one action plan from the multiple action plans based at least in part on the scoring of each of the multiple action plans.

9. The computer-implemented method of claim 8, wherein the at least one feature weighting operation comprises assigning weights to features comprising two or more of level of keyword matching, prior success rate of one or more comparable actions, and at least one of a platform and an environment associated with occurrence of the at least one data integration process-related issue.

10. The computer-implemented method of claim 1, wherein identifying at least one data integration process-related issue comprises processing log data associated with one or more extract, transform, load (ETL) processes.

11. The computer-implemented method of claim 1, wherein identifying at least one data integration process-related issue comprises classifying the at least one data integration process-related issue according to one or more issue causation-related categories.

12. The computer-implemented method of claim 1, further comprising:
training at least a portion of the transformer-based model using feedback related to automatically executing the at least part of the at least one action plan.

13. A non-transitory processor-readable storage medium having stored therein program code of one or more software programs, wherein the program code when executed by at least one processing device causes the at least one processing device:
to identify, in a transformer-based model of a processor-based machine learning system, at least one data integration process-related issue by extracting one or more features from log data associated with at least one data integration process, the processor-based machine learning system further comprising a natural language processing model, wherein the transformer-based model and the natural language processing model are interconnected in a processing pipeline of the processor-based machine learning system;
to identify, in the natural language processing model, content related to one or more of mitigating the at least one data integration process-related issue and resolving the at least one data integration process-related issue by processing one or more knowledge bases related to data integration processes in connection with at least a portion of the one or more extracted features;
to generate at least one action plan, based at least in part on portions of the identified content, for one or more of mitigating the at least one data integration process-related issue and resolving the at least one data integration process-related issue; and
to automatically execute at least part of the at least one action plan across one or more data sources involved in the at least one data integration process.

14. The non-transitory processor-readable storage medium of claim 13, wherein extracting one or more features from the log data associated with at least one data integration process comprises using a bidirectional encoder representations from transformers (BERT) model.

15. The non-transitory processor-readable storage medium of claim 13, wherein identifying content comprises using, in conjunction with a description of the at least one data integration process-related issue, at least one of one or more keyword matching techniques and one or more semantic search techniques.

16. The non-transitory processor-readable storage medium of claim 13, wherein generating at least one action plan comprises mapping the portions of the identified content to one or more executable scripts of action commands.

17. An apparatus comprising:
at least one processing device comprising a processor coupled to a memory;
the at least one processing device being configured:
to identify, in a transformer-based model of a processor-based machine learning system, at least one data integration process-related issue by extracting one or more features from log data associated with at least one data integration process, the processor-based machine learning system further comprising a natural language processing model, wherein the transformer-based model and the natural language processing model are interconnected in a processing pipeline of the processor-based machine learning system;
to identify, in the natural language processing model, content related to one or more of mitigating the at least one data integration process-related issue and resolving the at least one data integration process-related issue by processing one or more knowledge bases related to data integration processes in connection with at least a portion of the one or more extracted features;
to generate at least one action plan, based at least in part on portions of the identified content, for one or more of mitigating the at least one data integration process-related issue and resolving the at least one data integration process-related issue; and
to automatically execute at least part of the at least one action plan across one or more data sources involved in the at least one data integration process.

18. The apparatus of claim 17, wherein extracting one or more features from the log data associated with at least one data integration process comprises using a bidirectional encoder representations from transformers (BERT) model.

19. The apparatus of claim 17, wherein identifying content comprises using, in conjunction with a description of the at least one data integration process-related issue, at least one of one or more keyword matching techniques and one or more semantic search techniques.

20. The apparatus of claim 17, wherein generating at least one action plan comprises mapping the portions of the identified content to one or more executable scripts of action commands.
